(19) United States
(12) Patent Application Publication
(10) Pub. No.: US 2019/0266846 A1
(43) Pub. Date: Aug. 29, 2019

(54) SLOT FUELLED CITY BUILDING GAME

(71) Applicants: Anton Seleznov, Kyiv (UA); Sergii Potapov, Kyiv (UA); Volodymyr Shelest, Kyiv (UA)

(72) Inventors: Anton Seleznov, Kyiv (UA); Sergii Potapov, Kyiv (UA); Volodymyr Shelest, Kyiv (UA)

(21) Appl. No.: 15/979,451

(22) Filed: May 14, 2018

Related U.S. Application Data
(60) Provisional application No. 62/710,795, filed on Feb. 27, 2018.

(51) Int. Cl. G07F 17/32

(52) U.S. Cl. CPC G07F 17/3276; G07F 17/3213; G07F 17/3267; G07F 17/3223

(57) ABSTRACT

Methods, systems, and computer programs are presented for executing a slots-fueled city building adventure game. The slots-fueled city-building game is a standalone mobile casino application hosted for online competition gaming and is available for use on a smartphone, tablet, or other portable device. One method includes one or more players playing virtual slot machines in order to win prizes and accumulate virtual currency needed to build casino cities to further expand the player's casino empire and wealth.

### RELATED APPLICATIONS

This non-provisional application claims priority to a U.S. provisional application Ser. No. 62/710,795 filed on Feb. 27, 2018 and incorporated herewith by reference in its entirety.

### FIELD OF THE INVENTION

The present invention relates to systems and methods for playing online social games, and more particularly, online social casino-adventure games.

### BRIEF DESCRIPTION OF THE INVENTION

The popularity of casino games has extended to casino games played online. Online games such as poker, slots, blackjack, etc., are played by a large number of users on a computer. These prior art online games allowing players to interact with other players have become popular. However, most of the slot games in the market are very similar to the real-life slot games that have been around for a long time, and the online slot games merely seem to copy the user interface provided by the real slot machines, without adding much to the online experience. Because of this, differentiation between game providers is very small. Additionally, social interaction in online games is appealing to many users that wish to share some of their gaming experience with other friends, or other potential friends that may be made online. But existing slots online games do not currently provide many opportunities for social interaction with other players, nor they provide gaming interactions with other players, as the game of one slots player does not relate to the game of other slots players.

Some online games, such as chess or bridge, have a small number of players that play together at the same time. Other online games, such as Massively Multiplayer Online (MMO) games, can have a large number of players playing simultaneously. Online game operators, also referred to as social game operators, harness the power of online social networks, to design games that closely integrate the players' social graph data with their existing friendship connections.

The art is replete with various systems and methods for online games. U.S. Pat. No. 8,328,643 to Osvald et. al. teaches methods, systems, and computer programs for creating a crew to participate in a mission challenge in an online game are provided. The method identifies quests to complete the mission challenge. Each quest includes a plurality of tasks and each task includes a plurality of subtasks. A request feed is sent to members of a social graph requesting the members to join the crew and to participate in the completion of the subtasks of the mission challenge. The members in the social graph have a social relation with a user initiating the online game wherein the user is a mission leader managing the mission challenge. A distinct subtask is assigned to each member of the crew that responds to the request feed. Each crew member's progression in completing the mission challenge is monitored and status of the mission challenge is updated based on the progression made by each crew member of the crew.

Another prior art reference such as U.S. Pat. No. 8,979,627 to Walker et al., teaches a method comprises receiving an indication of a triggering event at a gaming device, determining a gaming content associated with the gaming device, identifying a public display on which is displayed non-gaming media content, and outputting the gaming content on the public display wherein the gaming content supersedes at least a portion of the non-gaming media content.

Still another prior art reference such as U.S. Pat. No. 9,302,177 to Guase et. al., for example, teaches methods, systems, and computer programs are presented for executing an adventure game. One method includes operations for sending an interface for a betting game, and for starting an online game that is displayed simultaneously with the interface for the betting game. The method further includes operations for detecting a bet placed in the betting game, and for determining an outcome of the bet in the betting game. An avatar is advanced along a path of the online game, where the amount of advancement of the avatar is based on the outcome of the bet.

Finally, U.S. Pat. No. 9,483,898 to Davidson et al. teaches a method of assigning a player-entry to a table so that said player-entry can participate in a hand of a particular card game at said table, wherein there is a plurality of players each having one or more respective player-entries for participating in a respective hand of said card game, wherein a player-entry that is actively participating in a hand of said card game may fold out of turn from said hand so as to no longer be actively participating in said hand, the method comprising: for a first player-entry of a first player, identifying an assignable table for said first player-entry from a plurality of tables for said card game, wherein a table is an assignable table for a particular player-entry if the assignment of said particular player-entry to said table cannot itself provide any player with further information about a hand in which an already assigned player-entry of said player is actively participating in addition to information about said hand that is available to said player only by virtue of the participation of said already assigned player-entry in said hand; and assigning the first player-entry to the identified assignable table.

It is in this context that embodiments arise. There is always a need for improved computer-implemented system and methods for executing an on-line multi-player adventure game of building a casino city allowing a bidirectional communication among the game server and the plurality of the adventure game players thereby adding more excitement for the players.

### SUMMARY OF THE INVENTION

A computer-implemented system and method for executing an on-line multi-player adventure game of the present invention is disclosed. It should be appreciated that the present embodiments can be implemented in numerous ways, such as a method, an apparatus, a system, a device, or a computer program on a computer readable medium. Several embodiments are described below. In one embodiment, a computer-implemented method for executing the game is provided. The system includes a game server for executing the adventure game, wherein the server includes one or more processors and a server communication circuit allowing a bidirectional communication among the game server and the plurality of the adventure game players.

The system also includes at least one graphical user interface (GUI) for displaying gaming content to each of the plurality of the adventure game players. The system includes at least one non-transitory computer-readable medium for storing computer-readable program instructions, wherein the medium is in communication with the one or more processors, and wherein the computer-readable program instructions, when executed by the one or more processors, cause the one or more processors to initiate by the server a gaming session of the on-line adventure game over the Internet, receive a player code from the one or more players in the gaming session, retrieve from the database accumulated credits or city points for the one or more players from one or more previous gaming sessions and add the accumulated credits or the accumulated city points to an account of each the one or more players in the gaming session.

The one or more processors of the system are further configured to conduct the adventure game, wherein the adventure game is played in alternating regimes, the regimes being at least one of a slots game regime or a city building regime, wherein the slots game regime is displayed with at least one slot machine, the at least one slot machine having an option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings upon.

The one or more processors are further configured to display a tutorial on the GUI to the one or more players, wherein the tutorial includes at least one of: one or more rules of the adventure game, one or more hints, one or more statuses, or one or more events of the adventure game.

The one or more processors are further configured to detect a bet placed for the at least one slots game, wherein the bet is placed on the at least one slot machine, wherein the at least one slot machine is configured to receive gaming media for providing credits to be bet and to add the credits to a credit amount display portion for the at least one slot machine, wherein the at least one slot machine comprises a bet-placing mechanism by which the one or more players can bet an amount of available credits based on the credit amount display portion, and spin the one or more slot wheels of the at least one slot machine for the detected bet and display an outcome to the one or more players, wherein the outcome comprises at least one of a winning outcome, or a non-winning outcome.

The one or more processors are further configured to, in response to the winning outcome, determine a win amount based on (i) the bet and (ii) a pay-out mechanism that is configured to determine at least one of: (i) one or more prizes of the slots game, wherein the prizes include at least one of a free-spin or a bonus game, or (ii) an amount of award credits or an amount of city points to be added to the account of the one or more players, wherein the credits or the city points are resources by which the one or more players build one or more buildings in the city building regime, and receive an input from the one or more players to use at least a portion of the resources to build the one or more buildings on the one or more city maps provided in the city building regime.

In another embodiment, a computer-implemented method for executing the game is provided. The computer-implemented method (the method) for executing an on-line multi-player adventure game of building a casino city, the method starts with initiating by the server the gaming session of the on-line adventure game over the Internet followed by receiving the player code from the one or more players in the gaming session followed by retrieving from the database accumulated credits or city points for the one or more players from one or more previous gaming sessions and add the accumulated credits or the accumulated city points to the account of each the one or more players in the gaming session.

The method further includes conducting the adventure game, wherein the adventure game is played in the alternating regimes, the regimes being at least one of a slots game regime or the city building regime, wherein the slots game regime is displayed with at least one slot machine, the at least one slot machine having the option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings upon.

Alluding to the above, the method includes displaying the tutorial on the GUI to the one or more players, wherein the tutorial includes at least one of: one or more rules of the adventure game, one or more hints, one or more statuses, or one or more events of the adventure game. The method is further followed by detecting the bet placed for the at least one slots game, wherein the bet is placed on the at least one slot machine, wherein the at least one slot machine is configured to receive gaming media for providing credits to be the bet and to add the credits to the credit amount display portion for the at least one slot machine, wherein the at least one slot machine comprises the bet-placing mechanism by which the one or more players can bet an amount of available credits based on the credit amount display portion. The method further includes spinning the one or more slot wheels of the at least one slot machine for the detected bet and display the outcome to the one or more players, wherein the outcome comprises at least one of the winning outcome, or a non-winning outcome.

In response to the winning outcome, the method includes determining the win amount based on (i) the bet and (ii) a pay-out mechanism that is configured to determine at least one of: (i) one or more prizes of the slots game, wherein the prizes include at least one of the free-spin or the bonus game, or (ii) the amount of award credits or the amount of city points to be added to the account of the one or more players, wherein the credits or the city points are resources by which the one or more players build one or more buildings in the city building regime. Moving forward, the method includes receiving the input from the one or more players to use at least a portion of the resources to build the one or more buildings on the one or more city maps provided in the city building regime.

An advantage of the present invention is to provide a novel computer-implemented concept of a gaming experience by combining an on-line casino gaming concept with an on-line adventure gaming concept into a unique multi-player casino-adventure game.

Another advantage of the present invention is to provide a unique gaming experience to be implemented within the context of the existing social networks.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a computer-implemented system for executing an on-line multi-player adventure game of the present invention;

FIGS. 2A through 7 show various Graphical User Interfaces (GUIs) illustrating a gameplay of a slots adventure game, wherein FIG. 2A shows an Exchange interface, FIG. 2B shows a map interface, FIG. 3A shows a quests interface, FIG. 3B shows a slot tournament interface, FIG. 4 shows a slot interface, FIG. 5 shows a choose task interface, FIG. 6 shows a tournaments interface, and FIG. 7 shows a wheel of fortune interface;

FIG. 8 is a schematic view of a computer-implemented flow diagram of the method for executing the on-line multi-player adventure game of the present invention;

FIG. 9 shows a high-level block diagram of a spin machine suitable for executing a slots adventure game according to one example embodiment;

FIG. 10 shows a high-level block diagram of a computer network environment suitable for executing a slots adventure game according to one example embodiment; and

FIG. 11 is a computer system that may be used to implement the methods for executing a slots adventure game according to an example embodiment.

### DETAILED DESCRIPTION OF THE INVENTION

The present disclosure describes a casino city slots adventure game, and also methods and systems for executing this game. It will be apparent that multiple embodiments of this disclosure may be practiced without some or all of these specific details. In other instances, well-known process operations have not been described in detail in order not to unnecessarily obscure the present embodiments. It is also noted that the embodiments described herein are described with reference to slots games, but the principles may be utilized in other gambling games, including both real-life games and online gambling games. The embodiments described herein should therefore not be interpreted to be exclusive or limiting, but rather exemplary or illustrative.

The following description of embodiments includes references to the accompanying drawings. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.” The term “player” shall mean a user of a computer, user device, spin machine or any other device enabling the user to play a slots adventure game of this disclosure. The term “in-game currency” shall mean virtual currency such as game points (or game experience points, coins, gems, etc.), which can be collected, acquired, spent, purchased, etc. during a gameplay of a slots adventure game of this disclosure.

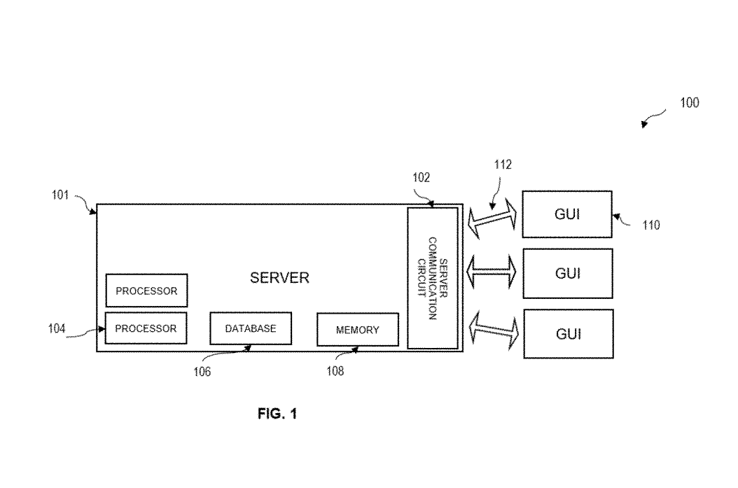

Referring to the Figures, wherein like numerals indicate like or corresponding parts, a computer-implemented system for executing an on-line multi-player adventure game of the present invention is disclosed and generally shown at 100 in FIG. 1. The system 100 includes a game server 101 for executing the adventure game, wherein the server 101 includes one or more processors 104 and a server communication circuit 102 allowing a bidirectional communication among the game server 101 and the plurality of the adventure game players.

The system 100 also a database 106 and at least one graphical user interface (GUI) 110 for displaying gaming content to each of the plurality of the adventure game players. The system 100 includes at least one non-transitory computer-readable medium 108 for storing computer-readable program instructions, wherein the medium 108 is in communication with the one or more processors 104, and wherein the computer-readable program instructions, when executed by the one or more processors 104, cause the one or more processors 104 to initiate by the server 101 a gaming session of the on-line adventure game over the Internet, receive a player code from the one or more players in the gaming session, retrieve from the database accumulated credits or city points for the one or more players from one or more previous gaming sessions and add the accumulated credits or the accumulated city points to an account of each the one or more players in the gaming session.

The one or more processors 104 of the system 100 are further configured to conduct the adventure game, wherein the adventure game is played in alternating regimes, the regimes being at least one of a slots game regime or a city building regime, wherein the slots game regime is displayed with at least one slot machine, the at least one slot machine having an option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings upon.

The one or more processors 104 are further configured to display a tutorial on the GUI 110 to the one or more players, wherein the tutorial includes at least one of: one or more rules of the adventure game, one or more hints, one or more statuses, or one or more events of the adventure game.

The one or more processors 104 are further configured to detect a bet placed for the at least one slots game, wherein the bet is placed on the at least one slot machine, wherein the at least one slot machine is configured to receive gaming media for providing credits to be bet and to add the credits to a credit amount display portion for the at least one slot machine, wherein the at least one slot machine comprises a bet-placing mechanism by which the one or more players can bet an amount of available credits based on the credit amount display portion, and spin the one or more slot wheels of the at least one slot machine for the detected bet and display an outcome to the one or more players, wherein the outcome comprises at least one of a winning outcome, or a non-winning outcome.

The one or more processors 104 are further configured to, in response to the winning outcome, determine a win amount based on (i) the bet and (ii) a pay-out mechanism that is configured to determine at least one of: (i) one or more prizes of the slots game, wherein the prizes include at least one of a free-spin or a bonus game, or (ii) an amount of award credits or an amount of city points to be added to the account of the one or more players, wherein the credits or the city points are resources by which the one or more players build one or more buildings in the city building regime, and receive an input from the one or more players to use at least a portion of the resources to build the one or more buildings on the one or more city maps provided in the city building regime.

The one or more processors 104 are further configured to prompt the one or more players in the at least one slots game regime to play one or more additional games against one or more other players of the multi-player adventure game to win extra credits or city points in the gaming session, wherein the one or more additional games comprise one or more tournament games, one or more duel games, or one or more attack games, and prompt the one or more players in the at least one slots game regime to play one or more quest games, one or more challenge games, or one or more task games to win extra credits or city points in the gaming session.

According to one embodiment of the invention, the slots game regime of the game including the at least one slot machine, further comprises one or more boosts, availability of which is determined by a predefined level of development of the casino city in the city building regime, or by attaining a predefined level of achievements, wherein the achievements are accumulated by playing the one or more additional games or by participating in the one or more quest games, the one or more challenge games, or the one or more task games, and the one or more slot machine reels having one or more symbols thereon, wherein the one or more symbols comprise a bonus outcome and a free spin outcome, and wherein at least one combination of the one or more symbols across one or more pay lines determines whether the outcome is the winning outcome or the non-winning outcome, wherein the winning outcome is generated upon the one or more pay lines displaying the at least one combination of one or more predefined symbols across the one or more pay lines, wherein the one or more predefined symbols comprise at least one of: one or more regular symbols or one or more special symbols, wherein the one or more special symbols comprise a wild symbol or a scatter symbol, and wherein the amount of award credits or the amount of city points is based on a type of the at least one combination of the one or more symbols.

The one or more processors 104 of the system 100 are further configured to prompt the one or more players to transition into the city building regime, and, in response to receiving an input from the one or more players to transition into the city building regime, present to the one or more players, via the GUI 110, a first level associated with the city map, wherein the first level is available for the one or more players to build the one or more buildings based on accumulated resources, and wherein the one or more buildings provide one or more new slots game regimes, present to the one or more players, via the GUI 110, one or more subsequent levels associated with the city map, wherein the one or more subsequent levels are locked and initially unavailable for the one or more players to build upon, wherein the first level and the one or more subsequent levels are displayed simultaneously, and unlock the one or more subsequent levels for the one or more players to build upon in response to the one or more players completing the first level.

The one or more processors 104, in the city building regime, are further configured to enable the one or more players to move around at least one of: (i) the first level or (ii) the one or more subsequent levels of the city map as a personalized character or enable the one or more players to visit city maps of one or more other players in the gaming session.

According to another embodiment of the invention, the city building regime of the game further comprises a store including a menu, the menu containing one or more items for purchase by the one or more players in order to develop the city map, or to make a gift for one or more other players in the adventure game, wherein the one or more items include at least one of: the one or more buildings, wherein the one or more buildings include resource-generating buildings and no-resource-generating buildings, the one or more slot machines, or one or more decoration items, wherein the menu contains one or more prices associated with the one or more items for purchase, and a warehouse for receiving the one or more items that were purchased by the one or more players.

According to yet another embodiment of the invention, the city building regime of the game further comprises a construction mode activated by the one or more players by selecting the one or more items in the warehouse and the one or more spots in the city map to build upon, wherein the construction mode comprises an “under construction” phase and a “construction completed” phase, wherein the “under construction phase” includes a predefined time requirement to complete the construction mode, and a construction mode accelerator for accelerating the “under construction” phase of the construction mode by the one or more players in exchange for the credits.

According to yet another embodiment of the invention, accumulation of the city points by the one or more players in the game is accelerated by building the one or more buildings or installing the one or more slot machines in the city building regime, completing the one or more quest games, the one or more task games, or the one or more challenge games assigned by the adventure game or by initiating and defeating the one or more other players in the gaming session in at least one of: the one or more tournament games, the one or more duel games, or the one or more attack games.

The one or more processors 104 of the system 100 are further configured to present to the one or more players, via the GUI 110, the one or more quest games, the one or more challenge games, or the one or more task games for at least one of: the first level, or the one or more subsequent levels, wherein the one or more quest games, the one or more challenge games, or the one or more task games include a text widget describing requirements for completing the one or more quest games, the one or more challenge games, or the one or more task games, and receive from the one or more players, via an input device, a selection of at least one of: the one or more quest games, the one or more challenge games, or the one or more task games to complete in at least one of: the first level, or the one or more subsequent levels, wherein the selected at least one of: the one or more quest games, the one or more challenge games, or the one or more task games are associated with a predefined amount of credits or city points being awarded for completion of each of the games.

According to yet another embodiment of the invention, the one or more slot machines in the slots game regime of the game include at least one boost mechanism by which the one or more slot machines are upgraded, wherein the upgrading improves the pay-out mechanism, wherein the at least one boost mechanism is active and available for the one or more players only one spin at a time.

According to yet another embodiment of the invention, the at least one boost mechanism of the game activates by completing by the one or more players a predefined number of the one or more tournament games, the one or more duel games, the one or more attack games, the one or more quest games, the one or more challenge games, or the one or more task games, and by upgrading to the one or more subsequent levels of the city map.

According to yet another embodiment of the invention, the game further comprises a building upgrade mechanism by which the one or more buildings of the virtual casino city are upgraded in order to earn more credits or city points for the one or more players, wherein the building upgrade mechanism is enabled by reaching a predefined amount of resources by the one or more players, or by completing a predefined number of one or more quests or one or more achievements by the one or more players, a decoration mechanism by which the at least one building of the virtual casino city is customized or decorated to earn more credits or city points for the one or more players, wherein the decoration mechanism is enabled by reaching a predefined amount of resources by the one or more players, or by completing a predefined number of the one or more quests or the one or more achievements by the one or more players, and a personalization mechanism by which one or more elements of the adventure game are customized by the one or more players, wherein the one or more elements are objects, icons, or figures other than buildings.

The one or more processors 104 of the system 100 are further configured to display on the GUI 110 to the one or more players the one or more players relevant statistical information including a level, time in the gaming session, the accumulated credits and the accumulated city points in the account, a number of visits of other players city maps, and a preferred building construction, and display to the one or more players one or more slot machine statistical data including a total number of spins, a total amount of bets, and a percentage of the winning outcome.

The one or more processors 104 of the system 100 are further configured to display on the GUI 110 an information frame of the one or more players, the information frame comprising a photo or an avatar of the one or more players, a mail box, a chat box, one or more achievements of the one or more players, and settings, display on the GUI 110 a city points frame of the one or more players for depiction of the one or more players level in the adventure game, the amount of city points in the account of the one or more players, and a progress bar identifying a required amount of city points to achieve a next level, display on the GUI 110 a credits frame of the one or more players for depiction of a credit amount belonging to the one or more players and displaying an option for the one or more players to replenish the credit amount, and display on the GUI 110 a map icon for the one or more players to select to switch from the slots game regime to view the city map corresponding to the one or more players level in the adventure game, or for the one or more players to select to switch from the city building regime to view a lobby of the adventure game.

The one or more processors 104 of the system 100 are further configured to receive from the one or more players a command for chatting with one or more other players in the gaming session and display at least one conversation amongst the one or more players and the one or more other players.

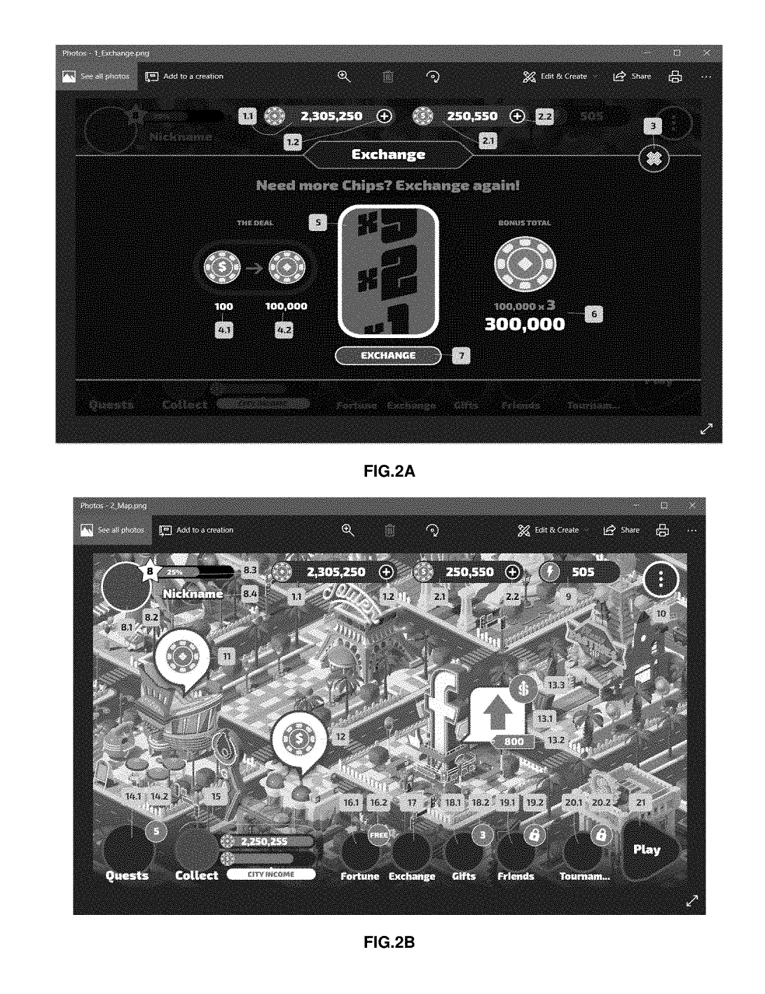

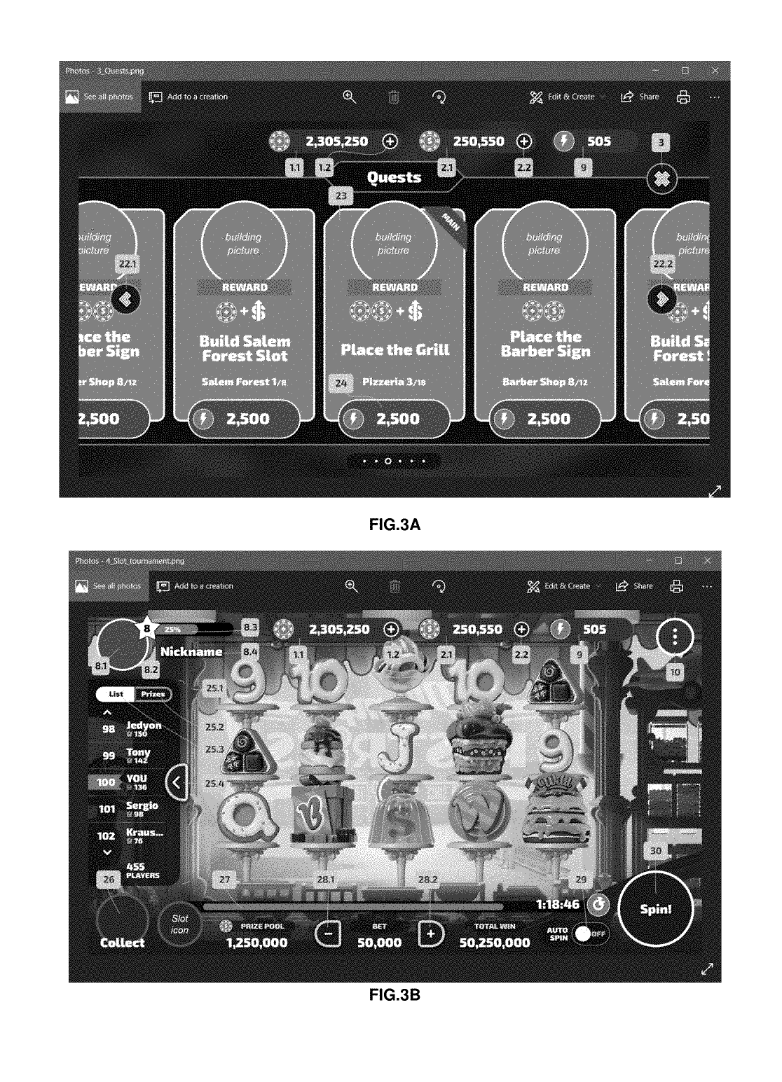

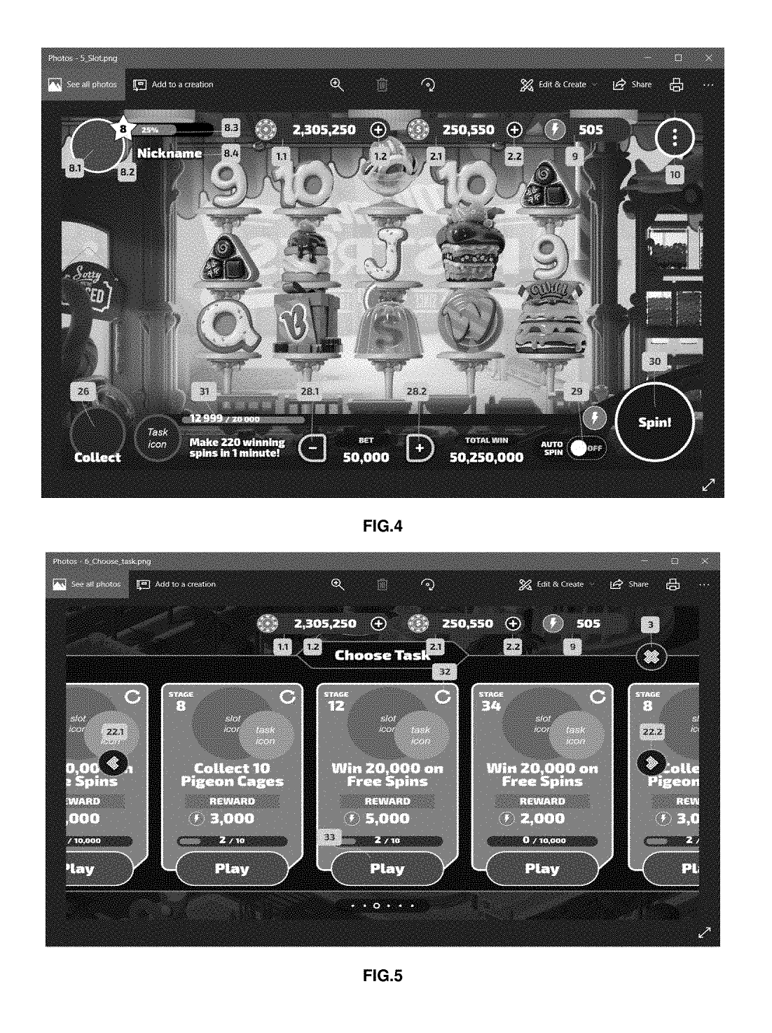

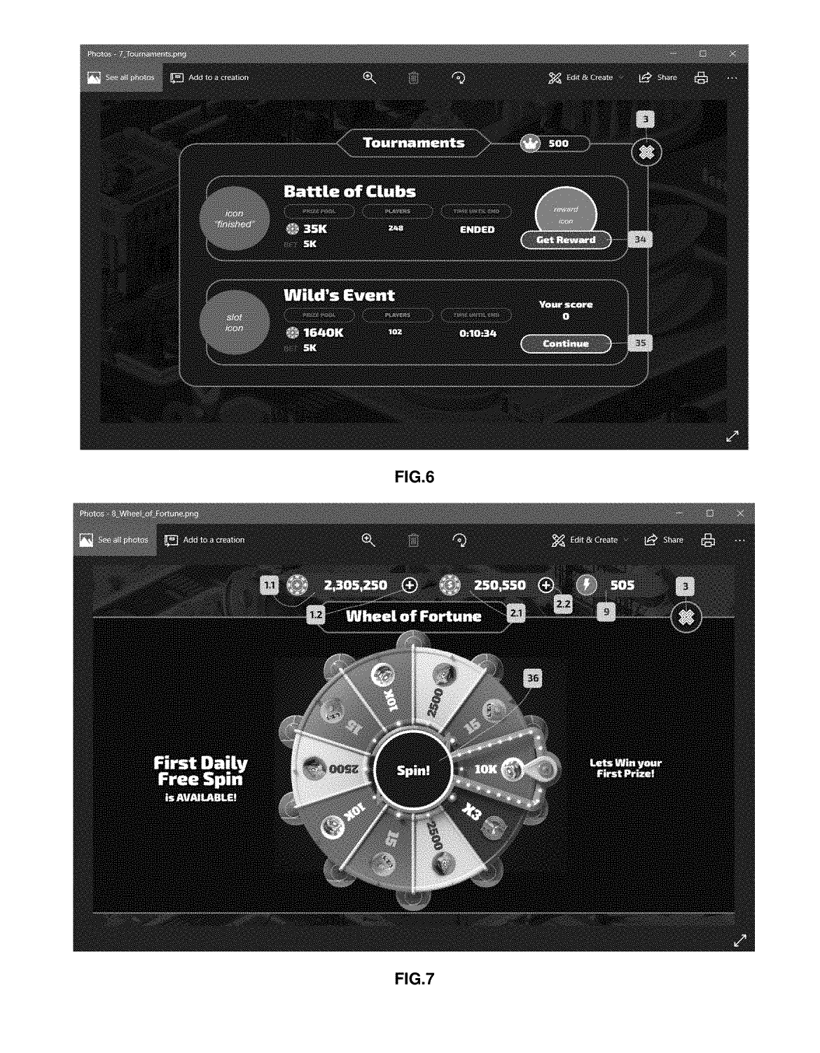

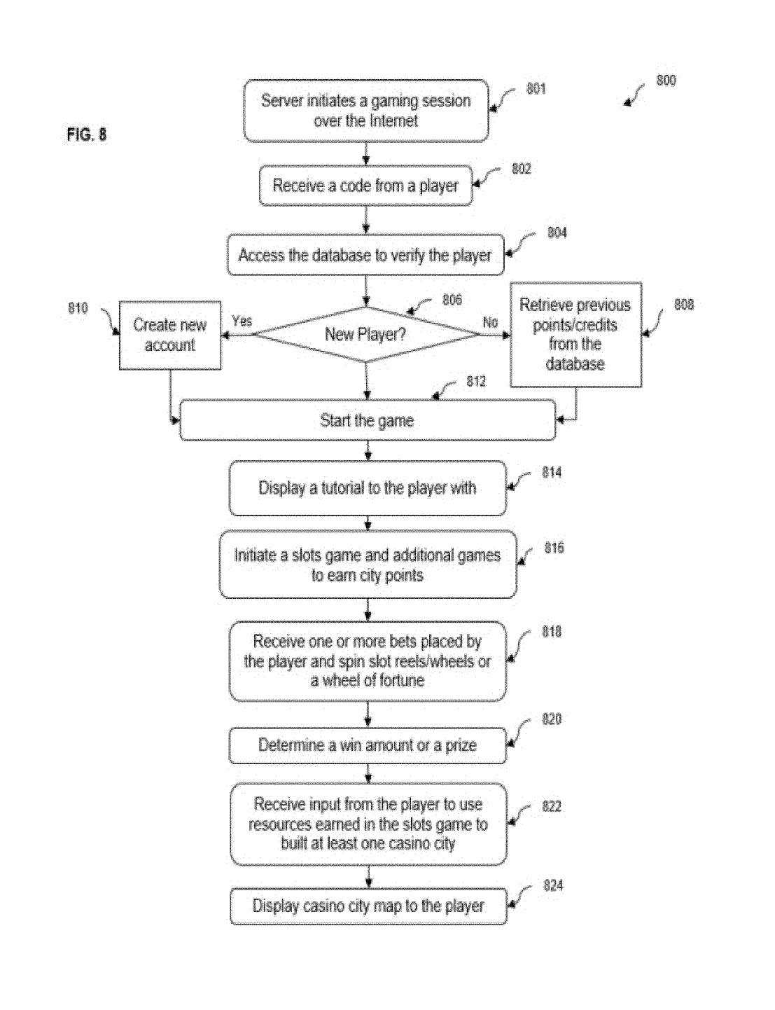

FIGS. 2A through 7 show various Graphical User Interfaces (GUIs) illustrating a gameplay of a slots adventure game, wherein FIG. 2A shows an Exchange interface, FIG. 2B shows a map interface, FIG. 3A shows a quests interface, FIG. 3B shows a slot tournament interface, FIG. 4 shows a slot interface, FIG. 5 shows a choose task interface, FIG. 6 shows a tournaments interface, and FIG. 7 shows a wheel of fortune interface.

FIG. 2A shows an Exchange interface, which includes the following elements: 1.1. Chips balance; 1.2. Button for chips refill; 2.1. Bucks balance; 2.2. Button for bucks refill; 3. Exit from exchange window; 4.1. Exchange rate in bucks; 4.2. Minimal amount of chips that player will receive during exchange; 5. Reel with chips multiplier for exchange; 6. Final amount of chips that player will obtain during exchange; 7. Exchange button, FIG. 2B shows a map interface, which includes the following elements: 8.1. Player's avatar; 8.2. Current level; 8.3. Progress bar of current level; 8.4. Nickname; 9. Energy balance; 10. Menu button; 11. Collecting chips button; 12. Collecting bucks button; 13.1. Building quest button; 13.2. Amount of energy required to completing the quest; 13.3. Label that informs player that completing this quest will provide user with permanent increasing of city's revenue; 14.1. Quests button; 14.2. Information about amount of new quests; 15. Collect button (it collects total city's revenue in bucks and chips; 16.1. Fortune button (button for Fortune Wheel); 16.2. Label that informs player about free spin on the Fortune Wheel; 17. Exchange button; 18.1. Gifts button; 18.2. Label that informs player about amount of new gifts; 19.1. Friends Button; 19.2. Label that informs player that Friends button is not available yet; 20.1. Tournaments button; 20.2. Label that informs player that Tournaments button is not available yet; 21. Play button, it transfer player to the “choose task/slots” window.

FIG. 3A shows a quests interface, which includes the following elements: 22.1. Slide left button; 22.2. Slide right button; 23. Quest card; 24. Button with amount of energy required for the quest. FIG. 3B shows a slot tournament interface, which includes the following elements: 25.1. Sidebar indicating player's position in tournament; 25.2. Prizes tab with description of prize fund of the tournament; 25.3. List tab, indicating player's position in tournament; 25.4. Button for minimizing the sidebar; 26. Collect button; 27. Progress bar of tournament's time; 28.1 Button of decreasing the bet; 28.2 Button of increasing the bet; 29. Autospin button; 30. Spin button. FIG. 4 shows a slot interface, which includes the following elements: 31. Progress bar of the task. FIG. 5 shows a choose task interface, which includes the following elements: 32. Skip task button and 33. Play button.

FIG. 6 shows a tournaments interface, which includes the following elements: 34. Get Reward button and 35. Continue button. FIG. 7 shows a wheel of fortune interface, which includes 36. Spin the Wheel button.

FIG. 8 illustrates a schematic view of a computer-implemented method for executing the on-line multi-player adventure game of the present invention generally shown at 800. The computer-implemented method (the method) 800 for executing an on-line multi-player adventure game of building a casino city, the method starts with initiating 801 by the server the gaming session of the on-line adventure game over the Internet followed by receiving 802 the player code from the one or more players in the gaming session followed by accessing 804 the database to verify the player. If the player is new 806 then new account will be created 810. If the player is known then the method includes the step of retrieving 808 from the database accumulated credits or city points for the one or more players from one or more previous gaming sessions and add the accumulated credits or the accumulated city points to the account of each the one or more players in the gaming session.

The method further includes conducting 812 the adventure game, wherein the adventure game is played in the alternating regimes, the regimes being at least one of a slots game regime or the city building regime, wherein the slots game regime is displayed with at least one slot machine, the at least one slot machine having the option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings upon. The method continuous with displaying 814 the tutorial on the GUI to the one or more players, wherein the tutorial includes at least one of: one or more rules of the adventure game, one or more hints, one or more statuses, or one or more events of the adventure game. The method also includes the step of initiating 816 a slots game and additional games to earn city points.

The method is further followed by detecting the bet placed for the at least one slots game, wherein the bet is placed on the at least one slot machine, wherein the at least one slot machine is configured to receive gaming media for providing credits to be the bet and to add the credits to the credit amount display portion for the at least one slot machine, wherein the at least one slot machine comprises the bet-placing mechanism by which the one or more players can bet an amount of available credits based on the credit amount display portion.

The method further includes spinning the one or more slot wheels of the at least one slot machine for the detected bet and display the outcome to the one or more players, wherein the outcome comprises at least one of the winning outcome, or a non-winning outcome. The method included receiving 818 one or more bets placed by the player and spin slot reels/wheels or a wheel of fortune. In response to the winning outcome, the method includes determining 820 the win amount based on (i) the bet and (ii) a pay-out mechanism that is configured to determine at least one of: (i) one or more prizes of the slots game, wherein the prizes include at least one of the free-spin or the bonus game, or (ii) the amount of award credits or the amount of city points to be added to the account of the one or more players, wherein the credits or the city points are resources by which the one or more players build one or more buildings in the city building regime.

Moving forward, the method includes receiving 822 the input from the one or more players to use at least a portion of the resources to build the one or more buildings on the one or more city maps provided in the city building regime. The method further includes prompting the one or more players in the at least one slots game regime to play one or more additional games against one or more other players of the multi-player adventure game to win extra credits or city points in the gaming session, wherein the one or more additional games comprise one or more tournament games, one or more duel games, or one or more attack games; and prompting the one or more players in the at least one slots game regime to play one or more quest games, one or more challenge games, or one or more task games to win extra credits or city points in the gaming session.

The method further includes prompting the one or more players to transition into the city building regime, and in response to receiving an input from the one or more players to transition into the city building regime such as presenting to the one or more players, via the GUI, a first level associated with the city map, wherein the first level is available for the one or more players to build the one or more buildings based on accumulated resources, and wherein the one or more buildings provide one or more new slots game regimes.

The method further includes presenting to the one or more players, via the GUI, one or more subsequent levels associated with the city map, wherein the one or more subsequent levels are locked and initially unavailable for the one or more players to build upon, wherein the first level and the one or more subsequent levels are displayed simultaneously and unlocking the one or more subsequent levels for the one or more players to build upon in response to the one or more players completing the first level.

Moving forward, the method enables the one or more players to move around at least one of: (i) the first level or (ii) the one or more subsequent levels of the city map as a personalized character; or enable the one or more players to visit city maps of one or more other players in the gaming session. The method further includes presenting to the one or more players, via the GUI, the one or more quest games, the one or more challenge games, or the one or more task games for at least one of: the first level, or the one or more subsequent levels, wherein the one or more quest games, the one or more challenge games, or the one or more task games include a text widget describing requirements for completing the one or more quest games, the one or more challenge games, or the one or more task games; and receiving from the one or more players, via an input device, a selection of at least one of: the one or more quest games, the one or more challenge games, or the one or more task games to complete in at least one of: the first level, or the one or more subsequent levels, wherein the selected at least one of: the one or more quest games, the one or more challenge games, or the one or more task games are associated with the predefined amount of credits or city points being awarded for completion.

The method further includes displaying on the GUI the information frame of the one or more players, the information frame comprising a photo or an avatar of the one or more players, a mail box, a chat box, one or more achievements of the one or more players, and settings. Moving further the method includes displaying on the GUI the city points frame of the one or more players for depiction of the one or more players level in the adventure game, the amount of city points in the account of the one or more players, and a progress bar identifying a required amount of city points to achieve a next level and displaying on the GUI a credits frame of the one or more players for depiction of a credit amount belonging to the one or more players and displaying an option for the one or more players to replenish the credit amount.

The method finally includes 824 displaying on the GUI the map icon for the one or more players to select to switch from the slots game regime to view the city map corresponding to the one or more players level in the adventure game, or for the one or more players to select to switch from the city building regime to view a lobby of the adventure game.

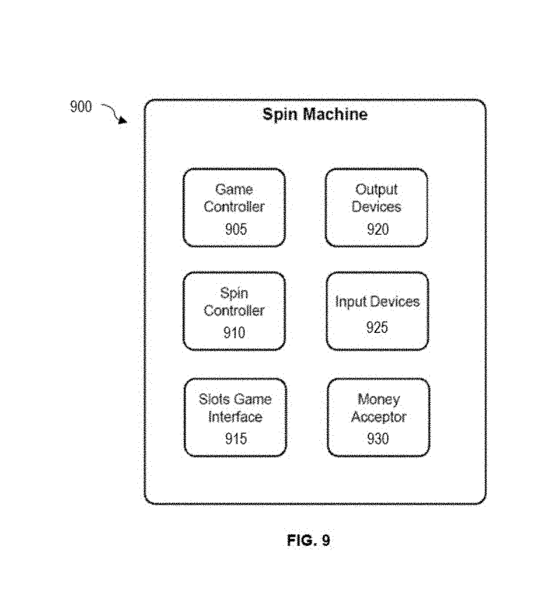

FIG. 9 shows a high-level block diagram of a spin machine 900 suitable for executing a slots adventure game according to one example embodiment. Generally, the spin machine 900 can refer to land-based apparatus for executing a slots adventure game. For example, the spin machine 900 can refer to a semi-mechanical or computer-based apparatus operatively combining various electrical-driven modules as follows. In some embodiments, the spin machine 900 can refer to a computing device (e.g. a personal computer, desktop computer, and a tablet computer), smart phone, cellular phone, server, game console, and so forth.

As shown in FIG. 9, the spin machine 900 includes a game controller 905 and a spin controller 910, both of which can be implemented using a variety of technologies. For example, the game controller 905 and the spin controller 910 may be implemented in software on a computer system or in hardware utilizing one or more processors, microprocessors, CPUs, controllers, other specially designed application-specific integrated circuits (ASICs), programmable logic devices, memory, or various combinations thereof. In one example, the game controller 905 and the spin controller 910 can include a series of processor-executable instructions residing on a transitory or non-transitory storage medium such as a disk drive or computer readable medium. In other example embodiments, the game controller 905 and the spin controller 910 include a plurality of logic devices and/or ASICs for implementing substantially the same functionality as the software-based solutions. In yet more embodiments, the game controller 910 are represented by a single computing device.

The spin machine 900 further includes a slots game interface 915, which can include a plurality of mechanical (tangible) slots reels, which are configured to spin upon receiving a control instruction from the spin controller 910. In alternative embodiments, the slots game interface 915 can refer to a graphical interface displayed on a screen, where the graphical interface includes motion images of virtual slots reels. In either example, the slots game interface 915 enables slots reels to spin and stop, such that predetermined reel image combinations can be determined to detect if the player has a winning combination.

The spin machine 900 further includes one or more output devices 920. Depending on the nature of the spin machine 900, the output devices 920 can include one or more of the following: a display, touch screen display, lighting devices, speakers, printer, prize delivery system, communications port, and so forth. The description of these elements is not given so as not to complicate the present disclosure, and it shall be clear that any available output devices known in the art can be used.

The spin machine 900 further includes one or more input devices 925. Depending on the nature of the spin machine 900, the input devices 925 can include one or more of the following: a keypad, keyboard, trackball, buttons, lever, microphone, video camera, communications port, and so forth. The description of these elements is not given so as not to complicate the present disclosure, and it shall be clear that any available output devices known in the art can be used.

The spin machine 1500 may also include, but optionally, a money acceptor 1530, which is configured to access and facilitate any monetary or non-monetary transactions, such as for purchasing in-game currency. In one example, the money acceptor 930 is configured to accept, recognize and collect cash or coins. In another example, the money acceptor 930 can be configured to access and process transactions with credit or debit cards, bank cards, reward cards, and so forth.

The above-described modules of spin machine 900 can work in aggregate thereby executing a game adventure game. More specifically, the game controller 905 can start with causing a display device (i.e., output device 920) to display to a player a virtual path for a slots adventure game having multiple slots games. The game controller 905 is further configured to present to the player one or more slots games (e.g., from unlocked levels) linked to the virtual path. The game controller 905 is further configured to receive from the player a selection, for example, by receiving a player's input made via one of the input devices 925. Upon receiving the player's selection, the game controller 905 can initiate one of the slots games.

Further, upon receiving an initiation instruction from the game controller 905, the spin controller 915 is configured to start the selected slots game based on the selection of the player and cause displaying via one of the output devices 920 a challenge associated with the selected slots game. Further, the spin controller 910 can receive one or more bets placed on the selected slots game by the player via at least one of the input devices 925. The spin controller 910 then causes slot reels to spin based on the one or more bets and a command received from the player via one of the input devices 925.

Further, the game controller 905 is configured to calculate in-game currency and/or city points based on a number of spinning events, the one or more bets, and/or one or more predetermined game rules. The game controller 905 determines whether or not the in-game currency and/or city points exceed a predetermined threshold amount of in-game currency or city points. If the in-game currency and/or city points exceed the predetermined threshold amount (or any other predetermined condition is satisfied), the game controller 905 unlocks a subsequent level of one or more slots games and/or of city maps to develop. The unlocking can be accompanied with presenting one or more visual and/or one or more audio effects caused by the game controller 905. In certain embodiments, the game controller 905 can cause delivering and/or audio effects during a gameplay.

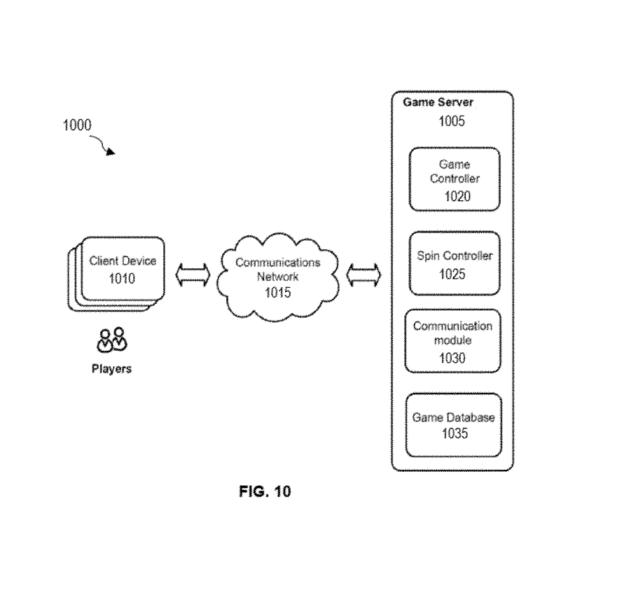

FIG. 10 shows a high-level block diagram of a computer network environment 1000 suitable for executing a slots adventure game according to one example embodiment. The environment 1000 includes a game server 1005 suitable for implementing online gaming for one or more players. The players use client devices 1010, which can refer to any suitable electronic device with networking capability. Some examples of client devices 1010 include, inter alia, a personal computer, desktop computer, tablet computer, smart phone, cellular phone, personal digital assistant, game con-sole, television system, and so forth. The client devices 1010 communicate with a communication module 1030 of the game server 1005 via a communications network 1015.

The communications network 1015 may include, for example, the Internet, local intranet, PAN (Personal Area Network), LAN (Local Area Network), WAN (Wide Area Network), MAN (Metropolitan Area Network), virtual private network (VPN), DSL (Digital Subscriber Line) connection, Ethernet connection, ISDN (Integrated Services Digital Network) line, cable modem, ATM (Asynchronous Transfer Mode) connection, or an FDDI (Fiber Distributed Data Interface) or CDDI (Copper Distributed Data Interface) connection. Furthermore, communications may also include links to any of a variety of wireless networks including WAP (Wireless Application Protocol), GPRS (General Packet Radio Ser-vice), GSM (Global System for Mobile Communication), CDMA (Code Division Multiple Access) or TDMA (Time Division Multiple Access), CDPD (cellular digital packet data), Bluetooth radio, or an IEEE 802.11-based radio frequency network. Accordingly, the communication module 1030 can include a network interface to cause communication with the client devices 1010 using, for example, Transmission Control Protocol/Internet Protocol (TCP/IP) protocols.

The game server 1005 includes a game controller 1020 and a spin controller 1025, which can provide substantially the same or similar functionality as the game controller 905 and the spin controller 910, respectively, as described above with reference to FIG. 9. In particular, the game server 1005 and the spin controller 1025 can be configured to execute the slots adventure game functionality. In certain embodiments, the game controller 1020 and the spin controller 1025 can be implemented as a combination of hardware modules and software modules.

For example, each of the game controller 1020 and the spin controller 1025 can be implemented as a computing device having one or more processors and one or more memories storing computer executable codes causing the game controller 1020 and the spin controller 1025 to execute the slots adventure game. In some embodiments, both the game controller 1020 and the spin controller 1025 are implemented in a single device, such as a processor with a memory.

The game server 1005 includes a game database 1035 for storing game information, player's profiles, information about a total amount of aggregated in-game currency and/or city points, information about a current location of a pointer associated with each player, information about a current difficulty level associated with each player, information about bets, game rules, design data, information about long-term challenges, music, videos, graphical information, audio information, and so forth.

The game server 1005 can also be associated with a website, which the player can access to play the slots adventure game. The game server 1005 can also be associated with a web service, which enables the players to access using mobile or software applications using, for example, a predetermined application program interface (API). Thus, the game server 1005 allows implementing an online casino, where players can enjoy the slots adventure game remotely using their client devices 1010.

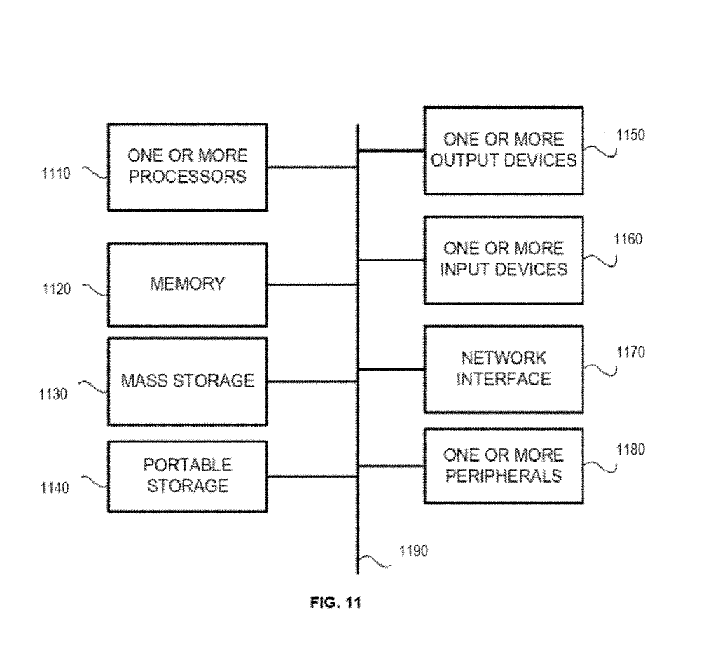

FIG. 11 illustrates an exemplary computing system 1100 that may be used to implement embodiments described herein. System 1100 of may be implemented in the contexts of the likes of spin machine 900, game server 1005, and/or client devices 1010. The computing system 1100 of FIG. 11 may include one or more processors 1110 and a memory 1120. Memory 1120 stores, in part, instructions and data for execution by processor 1110. Memory 1120 can store the executable code when the system 1100 is in operation. The system 1100 of FIG. 11 may further include a mass storage device 1130, a portable storage medium drive(s) 1140, one or more output devices 1150, one or more input devices 1160, a network interface 1170, and one or more peripheral devices 1180.

The components shown in FIG. 11 are depicted as being connected via a single bus 1190. The components may be connected through one or more data transport means. The processor 1110 and memory 1120 may be connected via a local microprocessor bus, and the mass storage device 1130, peripheral device(s) 1180, portable storage device 1140, and network interface 1170 may be connected via one or more input/output (I/O) buses.

The mass storage device 1130, which may be implemented with a magnetic disk drive or an optical disk drive, is a non-volatile storage device for storing data and instructions for use by a magnetic disk or an optical disk drive, which in turn may be used by the processor 1110. The mass storage device 1130 can store the system software for implementing embodiments described herein for purposes of loading that software into the memory 1120.

The portable storage medium drive(s) 1140 operates in conjunction with a portable non-volatile storage medium, such as a flash drive, to input and output data and code to and from the computer system 1100 of FIG. 11. The system software for implementing embodiments described herein may be stored on such a portable medium and input to the computer system 1100 via the portable storage medium drive(s) 1140.

The input devices 1160 provide a portion of a user interface. Input devices 1160 may include an alphanumeric keypad, such as a keyboard, for inputting alphanumeric and other information, or a pointing device, such as a mouse, a trackball, a stylus, or cursor direction keys. Additionally, the system 1100 as shown in FIG. 11 includes output devices 1150. Suitable output devices include speakers, printers, and displays.

The network interface 1170 can be utilized to communicate with external devices, external computing devices, servers, and networked systems via one or more communications networks such as one or more wired, wireless, or optical networks including, for example, the Internet.

The peripherals 1180 may include any type of computer support device to add additional functionality to the computer system. The peripheral device(s) 1180 may include a modem or a router. The components contained in the computer system 1100 of FIG. 11 are those typically found in computer systems that may be suitable for use with embodiments described herein and are intended to represent a broad category of such computer components that are well known in the art. Thus, the computer system 1100 of FIG. 11 can be a personal computer, hand held computing device, tele-phone, mobile computing device, workstation, server, mini-computer, mainframe computer, or any other computing device. The computer system 1100 can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., processor-readable or computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media.

Non-volatile media include, for example, optical or magnetic disks, such as a fixed disk. Volatile media include dynamic memory, such as system random access memory (RAM). Transmission media include coaxial cables, copper wire, and fiber optics, among others, including the wires that include one embodiment of a bus. Transmission media can also take the form of acoustic or light waves, such as those 20 generated during radio frequency (RF) and infrared (IR) data communications. Common forms of computer-readable media include, for example, a flash drive, hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEP-ROM, any other memory chip or cartridge, a carrier wave, or any other medium from which a computer can read. Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A computer-implemented system for executing an on-line multi-player adventure game of building a casino city, the system comprising:
a game server for executing the adventure game, wherein the server includes one or more processors and a server communication circuit allowing a bidirectional communication among the game server and a plurality of players of the adventure game;
at least one graphical user interface (GUI) for displaying gaming content to one or more players of the adventure game;
a database for storing the adventure game data and records;
at least one non-transitory computer-readable medium for storing computer-readable program instructions, wherein the medium is in communication with the one or more processors, and wherein the computer-readable program instructions, when executed by the one or more processors, cause the one or more processors to:
initiate by the server a gaming session of the on-line adventure game over the Internet;
receive a player code from the one or more players in the gaming session;
retrieve from the database accumulated credits or city points for the one or more players from one or more previous gaming sessions and add the accumulated credits or the accumulated city points to an account of each the one or more players in the gaming session;
conduct the adventure game, wherein the adventure game is played in alternating regimes, the regimes being at least one of a slots game regime or a city building regime, wherein the slots game regime is displayed with at least one slot machine, the at least one slot machine having an option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings thereon;
display a tutorial on the at least one GUI to the one or more players, wherein the tutorial includes at least one of: one or more rules of the adventure game, one or more hints, one or more statuses, or one or more events of the adventure game;
detect a bet placed for the at least one slots game, wherein the bet is placed on the at least one slot machine, wherein the at least one slot machine is configured to receive gaming media for providing credits to be bet and to add the credits to a credit amount display portion for the at least one slot machine, wherein the at least one slot machine comprises a bet-placing mechanism by which the one or more players can bet an amount of available credits based on the credit amount display portion;
spin the one or more wheels or the one or more reels of the at least one slot machine for the detected bet and display an outcome to the one or more players, wherein the outcome comprises at least one of a winning outcome, or a non-winning outcome;
in response to the winning outcome, determine a win amount based on (i) the bet and (ii) a pay-out mechanism that is configured to determine at least one of: (i) one or more prizes of the slots game, wherein the prizes include at least one of a free-spin or a bonus game, or (ii) an amount of award credits or an amount of city points to be added to the account of the one or more players, wherein the credits or the city points are resources by which the one or more players build one or more buildings in the city building regime; and
receive an input from the one or more players to use at least a portion of the resources to build the one or more buildings on the one or more city maps provided in the city building regime.

2. The system according to claim 1, wherein the one or more processors in the slots game regime are further configured to:
prompt the one or more players in the at least one slots game regime to play one or more additional games against one or more other players of the multi-player adventure game to win extra credits or city points in the gaming session, wherein the one or more additional games comprise one or more tournament games, one or more duel games, or one or more attack games; and
prompt the one or more players in the at least one slots game regime to play one or more quest games, one or more challenge games, or one or more task games to win extra credits or city points in the gaming session.

3. The system according to claim 2, wherein the slots game regime including the at least one slot machine, further comprising:
one or more boosts, availability of which is determined by a predefined level of development of the casino city in the city building regime, or by attaining a predefined level of achievements, wherein the achievements are accumulated by playing the one or more additional games or by participating in the one or more quest games, the one or more challenge games, or the one or more task games; and
the one or more slot machine reels having one or more symbols thereon, wherein the one or more symbols comprise a bonus outcome and a free spin outcome, and wherein at least one combination of the one or more symbols across one or more pay lines determines whether the outcome is the winning outcome or the non-winning outcome, wherein the winning outcome is generated upon the one or more pay lines displaying the at least one combination of one or more predefined symbols across the one or more pay lines, wherein the one or more predefined symbols comprise at least one of: one or more regular symbols or one or more special symbols, wherein the one or more special symbols comprise a wild symbol or a scatter symbol, and wherein the amount of award credits or the amount of city points is based on a type of the at least one combination of the one or more symbols.

4. The system according to claim 2, wherein the one or more processors are further configured to:
prompt the one or more players to transition into the city building regime, and in response to receiving an input from the one or more players to transition into the city building regime:
present to the one or more players, via the at least one GUI, a first level associated with the city map, wherein the first level is available for the one or more players to build the one or more buildings based on accumulated resources, and wherein the one or more buildings provide one or more new slots game regimes;
present to the one or more players, via the at least one GUI, one or more subsequent levels associated with the city map, wherein the one or more subsequent levels are locked and initially unavailable for the one or more players to build upon, wherein the first level and the one or more subsequent levels are displayed simultaneously; and
unlock the one or more subsequent levels for the one or more players to build upon in response to the one or more players completing the first level.

5. The system according to claim 4, wherein the one or more processors in the city building regime are further configured to:
enable the one or more players to move around at least one of: (i) the first level or (ii) the one or more subsequent levels of the city map as a personalized character; or
enable the one or more players to visit city maps of one or more other players in the gaming session.

6. The system according to claim 4, wherein the city building regime, further comprising:
a store including a menu, the menu containing one or more items for purchase by the one or more players in order to develop the city map, or to make a gift for one or more other players in the adventure game, wherein the one or more items include at least one of: the one or more buildings, wherein the one or more buildings include resource-generating buildings and no-resource-generating buildings, the one or more slot machines, or one or more decoration items, wherein the menu contains one or more prices associated with the one or more items for purchase; and
a warehouse for receiving the one or more items that were purchased by the one or more players.

7. The system according to claim 6, wherein the city building regime, further comprising:
a construction mode activated by the one or more players by selecting the one or more items in the warehouse and the one or more spots in the city map to build upon, wherein the construction mode comprises an “under construction” phase and a “construction completed” phase, wherein the “under construction phase” includes a predefined time requirement to complete the construction mode; and
a construction mode accelerator for accelerating the “under construction” phase of the construction mode by the one or more players in exchange for the credits.

8. The system according to claim 2, wherein accumulation of the city points by the one or more players is accelerated by building the one or more buildings or installing the one or more slot machines in the city building regime, completing the one or more quest games, the one or more task games, or the one or more challenge games assigned by the adventure game or by initiating and defeating the one or more other players in the gaming session in at least one of: the one or more tournament games, the one or more duel games, or the one or more attack games.

9. The system according to claim 4, wherein the one or more processors are further configured to:
present to the one or more players, via the at least one GUI, the one or more quest games, the one or more challenge games, or the one or more task games for at least one of: the first level, or the one or more subsequent levels, wherein the one or more quest games, the one or more challenge games, or the one or more task games include a text widget describing requirements for completing the one or more quest games, the one or more challenge games, or the one or more task games; and
receive from the one or more players, via an input device, a selection of at least one of: the one or more quest games, the one or more challenge games, or the one or more task games to complete in at least one of: the first level, or the one or more subsequent levels, wherein the selected at least one of: the one or more quest games, the one or more challenge games, or the one or more task games are associated with a predefined amount of credits or city points being awarded for completion.

10. The system according to claim 2, wherein the one or more slot machines in the slots game regime include at least one boost mechanism by which the one or more slot machines are upgraded, wherein the upgrading improves the pay-out mechanism, wherein the at least one boost mechanism is active and available for the one or more players only one spin at a time.

11. The system according to claim 3, wherein the at least one boost mechanism activates by completing by the one or more players a predefined number of the one or more tournament games, the one or more duel games, the one or more attack games, the one or more quest games, the one or more challenge games, or the one or more task games, and by upgrading to the one or more subsequent levels of the city map.

12. The system according to claim 1, further comprising:
a building upgrade mechanism by which the one or more buildings of the virtual casino city are upgraded in order to earn more credits or city points for the one or more players, wherein the building upgrade mechanism is enabled by reaching a predefined amount of resources by the one or more players, or by completing a predefined number of one or more quests or one or more achievements by the one or more players;
a decoration mechanism by which the at least one building of the virtual casino city is customized or decorated to earn more credits or city points for the one or more players, wherein the decoration mechanism is enabled by reaching a predefined amount of resources by the one or more players, or by completing a predefined number of the one or more quests or the one or more achievements by the one or more players; and
a personalization mechanism by which one or more elements of the adventure game are customized by the one or more players, wherein the one or more elements are objects, icons, or figures other than buildings.

12. The system according to claim 1, wherein the one or more processors are further configured to:
display on the at least one GUI to the one or more players the one or more players relevant statistical information including a level, time in the gaming session, the accumulated credits and the accumulated city points in the account, a number of visits of other players city maps, and a preferred building construction; and
display to the one or more players one or more slot machine statistical data including a total number of spins, a total amount of bets, and a percentage of the winning outcome.

13. The system according to claim 1, wherein the one or more processors are further configured to:
display on the at least one GUI an information frame of the one or more players, the information frame comprising a photo or an avatar of the one or more players, a mail box, a chat box, one or more achievements of the one or more players, and settings;
display on the at least one GUI a city points frame of the one or more players for depiction of the one or more players level in the adventure game, the amount of city points in the account of the one or more players, and a progress bar identifying a required amount of city points to achieve a next level;
display on the at least one GUI a credits frame of the one or more players for depiction of a credit amount belonging to the one or more players and displaying an option for the one or more players to replenish the credit amount; and
display on the at least one GUI a map icon for the one or more players to select to switch from the slots game regime to view the city map corresponding to the one or more players level in the adventure game, or for the one or more players to select to switch from the city building regime to view a lobby of the adventure game.

14. The system according to claim 1, wherein the one or more processors are further configured to:
receive from the one or more players a command for chatting with one or more other players in the gaming session; and
display at least one conversation amongst the one or more players and the one or more other players.

15. A computer-implemented method for executing an on-line multi-player adventure game of building a casino city, the method comprising:
initiating by a server a gaming session of the on-line adventure game over the Internet;
receiving a player code from the one or more players in the gaming session;
retrieving from a database accumulated credits or city points for the one or more players from one or more previous gaming sessions and add the accumulated credits or the accumulated city points to an account of each the one or more players in the gaming session;
conducting the adventure game, wherein the adventure game is played in alternating regimes, the regimes being at least one of a slots game regime or a city building regime, wherein the slots game regime is displayed with at least one slot machine, the at least one slot machine having an option to initiate by the one or more players at least one of: one or more tournament games, or one or more quest games, the slot machine further including at least one of: one or more slot machine wheels or one or more slot machine reels, and wherein the city building regime comprises one or more city maps and is displayed with one or more regions containing one or more spots for building one or more buildings thereon;
displaying a tutorial on a GUI to the one or more players, wherein the tutorial includes at least one of: one or more rules of the adventure game, one or more hints, one or more statuses, or one or more events of the adventure game;
detecting a bet placed for the at least one slots game, wherein the bet is placed on the at least one slot machine, wherein the at least one slot machine is configured to receive gaming media for providing credits to be bet and to add the credits to a credit amount display portion for the at least one slot machine, wherein the at least one slot machine comprises a bet-placing mechanism by which the one or more players can bet an amount of available credits based on the credit amount display portion;
spinning the one or more reels or the one or more wheels of the at least one slot machine for the detected bet and display an outcome to the one or more players, wherein the outcome comprises at least one of a winning outcome, or a non-winning outcome;
in response to the winning outcome, determining a win amount based on (i) the bet and (ii) a pay-out mechanism that is configured to determine at least one of: (i) one or more prizes of the slots game, wherein the prizes include at least one of a free-spin or a bonus game, or (ii) an amount of award credits or an amount of city points to be added to the account of the one or more players, wherein the credits or the city points are resources by which the one or more players build one or more buildings in the city building regime; and
receiving an input from the one or more players to use at least a portion of the resources to build the one or more buildings on the one or more city maps provided in the city building regime.

16. The method according to claim 1, further comprising:
prompting the one or more players in the at least one slots game regime to play one or more additional games against one or more other players of the multi-player adventure game to win extra credits or city points in the gaming session, wherein the one or more additional games comprise one or more tournament games, one or more duel games, or one or more attack games; and
prompting the one or more players in the at least one slots game regime to play one or more quest games, one or more challenge games, or one or more task games to win extra credits or city points in the gaming session.

17. The method according to claim 16, further comprising:
prompting the one or more players to transition into the city building regime, and in response to receiving an input from the one or more players to transition into the city building regime:
presenting to the one or more players, via the GUI, a first level associated with the city map, wherein the first level is available for the one or more players to build the one or more buildings based on accumulated resources, and wherein the one or more buildings provide one or more new slots game regimes;
presenting to the one or more players, via the GUI, one or more subsequent levels associated with the city map, wherein the one or more subsequent levels are locked and initially unavailable for the one or more players to build upon, wherein the first level and the one or more subsequent levels are displayed simultaneously; and
unlocking the one or more subsequent levels for the one or more players to build upon in response to the one or more players completing the first level.

18. The method according to claim 17, further comprising:
enabling the one or more players to move around at least one of: (i) the first level or (ii) the one or more subsequent levels of the city map as a personalized character; or
enabling the one or more players to visit city maps of one or more other players in the gaming session.

19. The method according to claim 18, further comprising:
presenting to the one or more players, via the GUI, the one or more quest games, the one or more challenge games, or the one or more task games for at least one of: the first level, or the one or more subsequent levels, wherein the one or more quest games, the one or more challenge games, or the one or more task games include a text widget describing requirements for completing the one or more quest games, the one or more challenge games, or the one or more task games; and
receiving from the one or more players, via an input device, a selection of at least one of: the one or more quest games, the one or more challenge games, or the one or more task games to complete in at least one of: the first level, or the one or more subsequent levels, wherein the selected at least one of: the one or more quest games, the one or more challenge games, or the one or more task games are associated with a predefined amount of credits or city points being awarded for completion.

20. The method according to claim 19, further comprising:
displaying on the GUI an information frame of the one or more players, the information frame comprising a photo or an avatar of the one or more players, a mail box, a chat box, one or more achievements of the one or more players, and settings;
displaying on the GUI a city points frame of the one or more players for depiction of the one or more players level in the adventure game, the amount of city points in the account of the one or more players, and a progress bar identifying a required amount of city points to achieve a next level;
displaying on the GUI a credits frame of the one or more players for depiction of a credit amount belonging to the one or more players and displaying an option for the one or more players to replenish the credit amount; and
displaying on the GUI a map icon for the one or more players to select to switch from the slots game regime to view the city map corresponding to the one or more players level in the adventure game, or for the one or more players to select to switch from the city building regime to view a lobby of the adventure game.
